(19) United States
(12) Patent Application Publication
(10) Pub. No.: US 2015/0227641 A1
(43) Pub. Date: Aug. 13, 2015

(54) RADAR TARGET CROSS SECTION SIMULATION

(71) Applicant: The Government of the United States, as represented by the Secretary of the Army, Washington, DC (US)

(72) Inventor: Mark Govoni, Abingdon, MD (US)

(73) Assignee: The Government of the United States, as represented by the Secretary of the Army, Washington, DC (US)

(21) Appl. No.: 14/178,682

(22) Filed: Feb. 12, 2014

(51) Int. Cl. G06F 17/50; G06F 17/10

(52) U.S. Cl. CPC G06F 17/50; G06F 17/10

(57) ABSTRACT

Various embodiments are described that relate to production of an array pattern and an element pattern for an antenna. A user can enter input parameters by way of a computer interface and based on these input parameters the array pattern and element pattern can be produced. The array pattern and the element pattern are produced such that a monitoring apparatus does not identify the antenna as an object of interest when the antenna is implemented with the element pattern and the array pattern.

### GOVERNMENT INTEREST

The innovation described herein may be manufactured, used, imported, sold, and licensed by or for the Government of the United States of America without the payment of any royalty thereon or therefore.

### BACKGROUND

Antenna systems can be used to communicate information. These systems can be constructed in a fixed location or be constructed such that the location can be mobile based on specific needs. Various entities can attempt to determine the presence and/or location of these systems. Determining the presence and/or location can be done by sending a signal and determining how that signal responds. However, the operators of these systems may not want their presence and/or location to be known to these various entities.

### SUMMARY

In one embodiment, a system comprises a reception component, a pattern component, an element component, and an output component. The reception component, the pattern component, the element component, the output component, or a combination thereof can be implemented, at least in part, as non-software. The reception component is configured to receive a parameter set while the pattern component is configured to produce an array pattern for an antenna that is based, at least in part, on the parameter set. The element component is configured to produce an element pattern for the antenna that is based, at least in part, on the parameter set and the output component configured to output the array pattern and the element pattern. The element pattern is such that a monitoring apparatus does not identify the antenna as an object of interest and the array pattern is such that the monitoring apparatus does not identify the antenna as the object of interest.

In one embodiment, a non-transitory computer-readable medium stores processor-executable instructions that when executed by a processor cause the processor to perform a method. The method comprises collecting a parameter set, generating a pattern set, and causing the pattern set to be outputted. The pattern set can comprise a randomized array pattern for an antenna that is based, at least in part, on the parameter set that is such that a monitoring apparatus does not identify the antenna as an object of interest. The pattern set can also comprise a randomized element pattern for the antenna that is based, at least in part, on the parameter set and that is such that the monitoring apparatus does not identify the antenna as the object of interest.

In one embodiment, a processor and a non-transitory computer-readable storage medium communicatively coupled to the processor and storing processor executable components to facilitate operation of components. The components comprise a reception component that receives a parameter set, the parameter set comprising an antenna parameter set and an equation variable set. The components also comprise a production component that produces a pattern set that is based, at least in part, on the parameter set. The components further comprise an output component that causes output of the pattern set. The pattern set comprises a randomized array pattern for an antenna and a randomized element pattern for the antenna. The randomized element pattern is such that a monitoring apparatus does not identify the antenna as an object of interest while the randomized array pattern is such that the monitoring apparatus does not identify the antenna as the object of interest.

### BRIEF DESCRIPTION OF THE DRAWINGS

Incorporated herein are drawings that constitute a part of the specification and illustrate embodiments of the detailed description. The detailed description will now be described further with reference to the accompanying drawings as follows:

FIG. 1 illustrates one embodiment of a system comprising a reception component, a pattern component, an element component, and an output component;

FIG. 2 illustrates one embodiment of a system comprising the reception component, a production component, and the output component;

FIG. 3 illustrates one embodiment of a system comprising a processor and a non-transitory computer-readable medium;

FIG. 4 illustrates one embodiment of a method comprising three actions;

FIG. 5 illustrates one embodiment of a method comprising seven actions;

FIG. 6 illustrates one embodiment of a flow chart that incorporates use of a computer interface;

FIGS. 7A and 7B illustrate two embodiments of cross sections;

FIGS. 8A, 8B, and 8C illustrate three embodiments of array patterns;

FIG. 9 illustrates one embodiment of geometry of a circular array; and

FIGS. 10A, 10B, and 10C illustrate three embodiments of element patterns.

### DETAILED DESCRIPTION

In one embodiment, a first entity may want their physical location and/or their presence to remain unknown to a second entity. In one example, the first entity and second entity may be combative military forces or commercial competitors. For one entity to locate another, the finding entity can send out a signal that returns with characteristics of an object of interest. Example characteristics can include expected power or duration of the returned signal.

To remain undetected, the first entity can be configured in a randomized manner such that the return signal is indistinguishable from a other returned signals (e.g., signals returned off buildings, trees, etc.).

The following includes definitions of selected terms employed herein. The definitions include various examples. The examples are not intended to be limiting.

“One embodiment”, “an embodiment”, “one example”, “an example”, and so on, indicate that the embodiment(s) or example(s) can include a particular feature, structure, characteristic, property, or element, but that not every embodiment or example necessarily includes that particular feature, structure, characteristic, property or element. Furthermore, repeated use of the phrase “in one embodiment” may or may not refer to the same embodiment.

“Computer-readable medium”, as used herein, refers to a medium that stores signals, instructions and/or data. Examples of a computer-readable medium include, but are not limited to, non-volatile media and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, other optical medium, a Random Access Memory (RAM), a Read-Only Memory (ROM), a memory chip or card, a memory stick, and other media from which a computer, a processor or other electronic device can read. In one embodiment, the computer-readable medium is a non-transitory computer-readable medium.

“Component”, as used herein, includes but is not limited to hardware, firmware, software stored on a computer-readable medium or in execution on a machine, and/or combinations of each to perform a function(s) or an action(s), and/or to cause a function or action from another component, method, and/or system. Component may include a software controlled microprocessor, a discrete component, an analog circuit, a digital circuit, a programmed logic device, a memory device containing instructions, and so on. Where multiple components are described, it may be possible to incorporate the multiple components into one physical component or conversely, where a single component is described, it may be possible to distribute that single component between multiple components.

“Software”, as used herein, includes but is not limited to, one or more executable instructions stored on a computer-readable medium that cause a computer, processor, or other electronic device to perform functions, actions and/or behave in a desired manner. The instructions may be embodied in various forms including routines, algorithms, modules, methods, threads, and/or programs including separate applications or code from dynamically linked libraries.

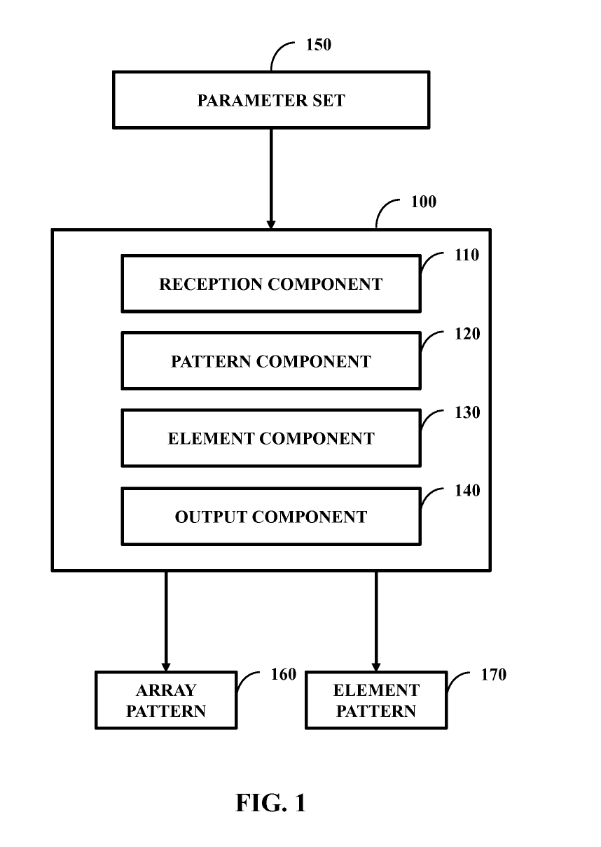

FIG. 1 illustrates one embodiment of a system 100 comprising a reception component 110, a pattern component 120, an element component 130, and an output component 140. The reception component 110 can be configured to receive a parameter set 150. The parameter set 150 can be received from a wired or wireless connection, be transferred from enter in a computer interface, be received through proactive analysis, etc.

In one embodiment, the parameter set 150 can comprise an antenna parameter set, such as an array radius and/or an element number. In one example, a user can submit the parameter set based on physical limitations or characteristics of an anticipated antenna. With this example, the user can know of a set number of elements for use with the antenna as well as an acceptable radius for the antenna. In one instance, the user may know that the radius is 0.1 meters with 100 elements available.

In one embodiment, the parameter set 150 can comprise an equation variable set, such as a carrier frequency and/and a beam steering angle set. In one example, a computer can determine the carrier frequency and/or the beam steering angles (e.g., one or more angle where majority of energy is focused). In one instance the carrier frequency can be set to 18 millimeters while the beam steering angle is 0 degrees.

The pattern component 120 can be configured to produce an array pattern 160 for an antenna. The array pattern 160 can be is based, at least in part, on the parameter set 150. The array pattern 160 can be configured over 360 degrees with a maximum magnitude of 1.

The element component 130 can be configured to produce an element pattern 170 (e.g., circular pattern of elements) for the antenna, such as concurrently with the pattern component 120 producing the array pattern 160. The element pattern 170 can be based, at least in part, on the parameter set 150. In one embodiment, the element pattern 170 can be a distribution of a plurality of elements along a circular pattern with a specific angle for individual elements of the plurality of elements. Using the above discussed instance, along the element pattern 170 can be configured such that the radius is 0.1 meters and thus keeping the antenna consistent with the parameter set 150.

A monitoring apparatus can attempt to determine the presence and/or location of the antenna. However, the antenna operator may not want the presence and/or location known to the monitoring apparatus. Therefore the array pattern 160 and/or the element pattern 170 can be such that a monitoring apparatus does not identify the antenna as an object of interest. In one example, the monitoring apparatus can detect the antenna, but the antenna will not be distinguishable for other items such as trees. Therefore, the monitoring apparatus will not be able determine the presence of the antenna.

In one embodiment, the array pattern 160 and/or the element pattern 170 is randomized. If the system 100 would function without randomization, then the same or similar array patterns 160 and/or element patterns 170 may be produced. Therefore, the monitoring apparatus may be able to learn of a likeness between patterns and use this likeness to learn of the presence and/or location of the antenna or subsequent antennas. Therefore, the array pattern 160 and/or element pattern 170 can be subjected to randomization in order to remove this ability to identify the antenna.

The output component 140 can be configured to output the array pattern 160 and the element pattern 170. The array pattern 160 and/or the element pattern 170 can be outputted to a computer interface used to submit at least part of the parameter set 150. In one embodiment, the reception component 110, the pattern component 120, the element component 130, the output component 140, or a combination thereof are implemented, at least in part, as non-software (e.g., hardware).

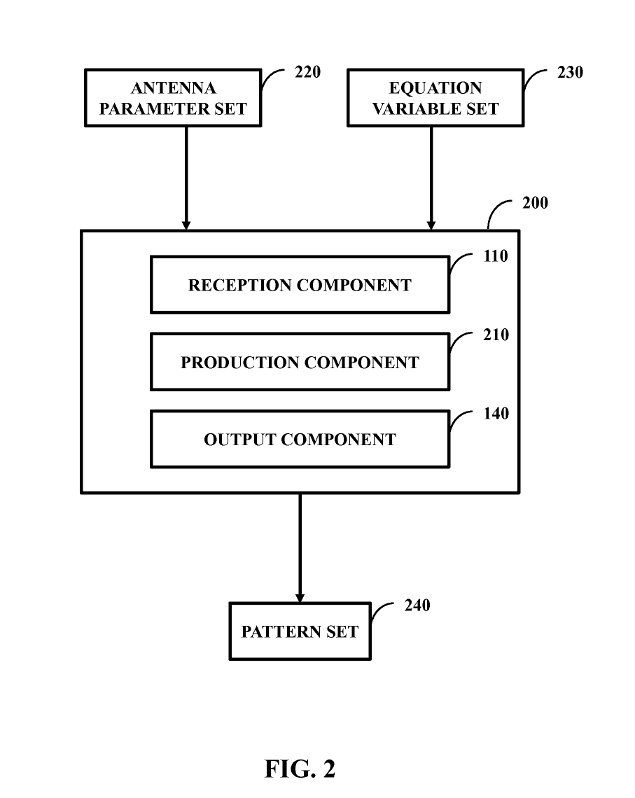

FIG. 2 illustrates one embodiment of a system 200 comprising the reception component 110, a production component 210, and the output component 140. The reception component 110 receives a parameter set (e.g., the parameter set 110 of FIG. 1). The parameter set can comprise an antenna parameter set 220 (e.g., an array radius and an element number) and an equation variable set 230 (e.g., a carrier frequency and a beam steering angle set). The production component 210 produces a pattern set 240 that is based, at least in part, on the parameter set. The production component 210 can produce the pattern set 240 through use of an array factor formula and through use of a normalized electric field formula. The output component 140 causes output of the pattern set 240.

In one embodiment, the pattern set comprises a randomized array pattern for an antenna and a randomized element pattern for the antenna. The randomized array pattern can be such that the monitoring apparatus does not identify the antenna as the object of interest. Likewise, the randomized element pattern can be such that a monitoring apparatus does not identify the antenna as an object of interest.

In one embodiment, different iterations even with the same antenna parameter set 220 and the same equation variable set 230 can produce a different pattern set (e.g., different array pattern and different element pattern). In one example, the antenna is a first antenna, the pattern set is a first pattern set, the randomized array pattern is a first randomized array pattern, and the randomized element pattern is a first randomized element pattern. The production component produces a second pattern set that is based, at least in part on the parameter set. The second pattern set can comprise a second randomized array pattern that is for a second antenna that is different from the first randomized array pattern for the first antenna as well as a second randomized element pattern for the second antenna that is different from the first randomized array pattern for the first antenna. The second randomized array pattern can be such that the monitoring apparatus does not identify the second antenna as the object of interest and the second pattern set is produced through use of the array factor formula and through use of the normalized electric field formula. In addition, the second randomized element pattern can be such that the monitoring apparatus does not identify the second antenna as the object of interest and can be a distribution of a plurality of elements along a circular pattern with a specific angle for individual elements of the plurality of elements. The first randomized element pattern and the second randomized element pattern can be a distribution of a plurality of elements along a circular pattern with a specific angle for individual elements of the plurality of elements.

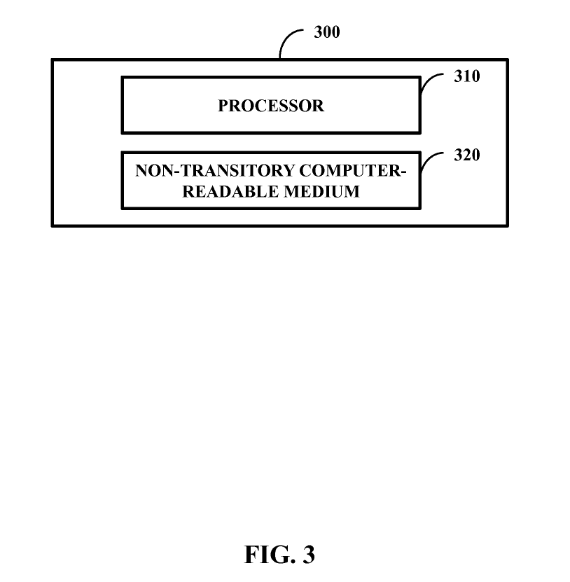

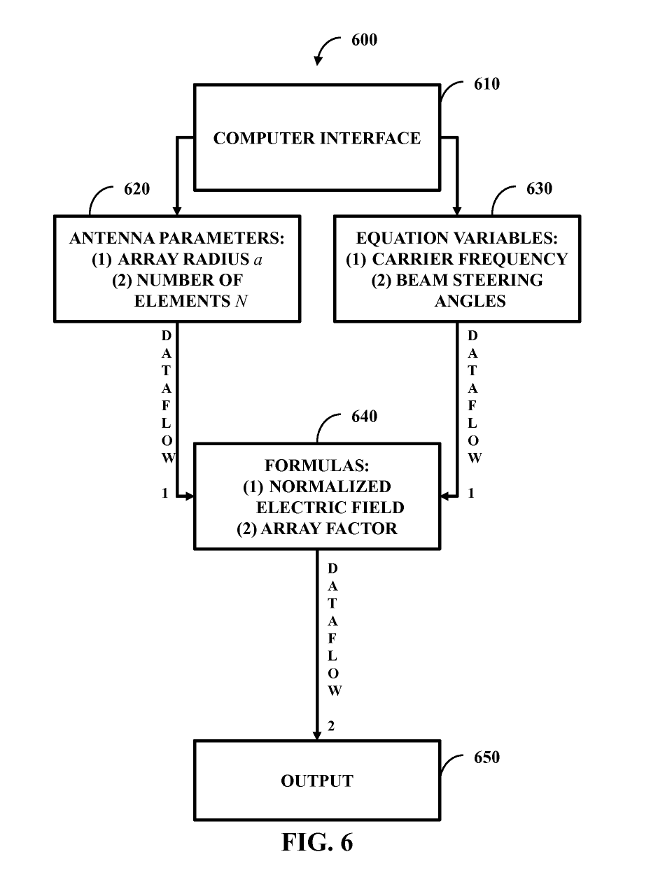

FIG. 3 illustrates one embodiment of a system 300 comprising a processor 310 and a non-transitory computer-readable medium 320. In one embodiment the non-transitory computer-readable medium 320 is communicatively coupled to the processor 310 and stores a command set executable by the processor 310 to facilitate operation of at least one component disclosed herein (e.g., the reception component 110, the production component 210 and/or the output component 140 of FIG. 2). In one embodiment, at least one component disclosed herein (e.g., the reception component 110, the pattern component 120, the element component 130, and/or the output component 140 of FIG. 1) can be implemented, at least in part, by way of non-software, such as implemented as hardware by way of the system 300. In one embodiment the non-transitory computer-readable medium 320 is configured to store processor-executable instructions that when executed by the processor 310 cause the processor 310 to perform a method disclosed herein (e.g., the method 400 and/or the method 500 discussed below as well as the method discussed with regard to FIG. 6 below).

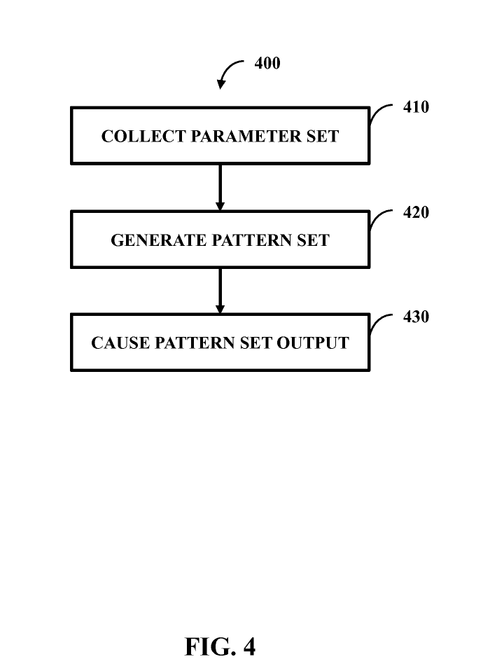

FIG. 4 illustrates one embodiment of a method 400 comprising three actions 410-430. At 410 collection of a parameter set occurs, at 420 generation of a pattern set takes place (e.g., through use of a normalized electric field formula and/or an array factor formula), and at 430 causing the pattern set to be outputted takes place. The pattern set can comprise a randomized array pattern for an antenna that is based, at least in part, on the parameter set that is such that a monitoring apparatus does not identify the antenna as an object of interest. The pattern set can also comprise a randomized element pattern for the antenna that is based, at least in part, on the parameter set and that is such that the monitoring apparatus does not identify the antenna as the object of interest. The parameter set can comprise an antenna parameter set (e.g., an array radius and an element number) and/or an equation variable set (e.g., a carrier frequency and a beam steering angle set) while the randomized element pattern can be distribution of a plurality of elements along a circular pattern with a specific angle for individual elements of the plurality of elements.

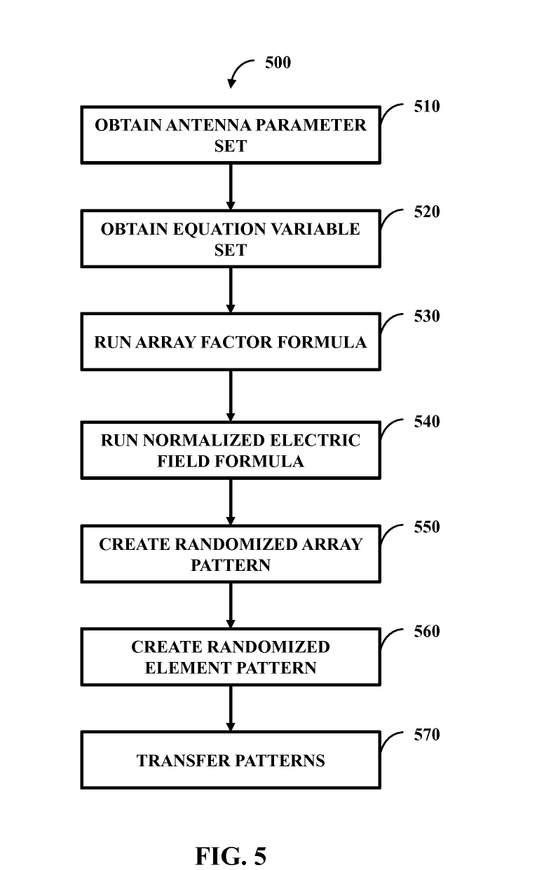

FIG. 5 illustrates one embodiment of a method 500 comprising seven actions 510-570. At 510 an antenna parameter set is obtained while at 520 an equation variable set is obtained. With this information, an array factor formula can be run at 530 and a normalized electric field formula can be run at 540. The results of these formulas can be used to create a randomized array pattern at 550 and a randomized element pattern at 560. These two patterns can be transferred 570 (e.g., transferred to a computer) and a construction apparatus can construct an antenna based on the randomized array pattern and the randomized element pattern.

FIG. 6 illustrates one embodiment of a flow chart 600 that incorporates use of a computer interface 610. The flow chart 600 can be used in practice of aspects disclosed herein. Aspects disclosed herein can be used in the fields of electromagnetic science and electronics technology.

To practice at least one aspect disclosed herein a method for simulating radar target cross section can be used that employs a circular antenna array having a random element placement pattern. The method can be practiced by use of software, such as running a software simulation. Progression through the software simulation can result in plots of the antenna array pattern and the corresponding antenna element placement pattern along the perimeter of the circular array. By inspection of the simulation outputs, the user can be able to confirm the behavior of the antenna pattern. With this knowledge, a designer of such an antenna can efficiently engineer the antenna specifications for real-world applications.

The method provides a convenient and effective manner for simulating a specific antenna array pattern and designing the corresponding circular array. The application of this method caters to military interests as well as extension to radio communications. A radio frequency in such a communication, and its corresponding radio wavelength, can have an arbitrary amount of radiating elements and can have any number of random array patterns.

The method addresses limitations with conventional practices for effectively designing antenna array patterns pertaining to applications relating to the realization of radar target cross sections. Specifically, the method provides a unique ability to simulate a radar target cross section using a circular antenna array having random element placement patterns, where the specific element placement pattern is provided as part of the simulation output.

The method can be used for simulating a radar target cross section by way of a circular array whose antenna elements have been deliberately placed in a random fashion along the perimeter of a circular dielectric. The user can interact with the computer interface 610. A software program can operate in conjunction with the computer interface 610. After initializing the software program, the user can be prompted to input two sets of data parameters to run the simulation: antenna parameters 620 and equation variables 630. After inputting the parameters, the simulation uses formulas 640 to produce plots of the antenna array pattern and the corresponding element placement pattern that are yielded as output 650. In one embodiment, the output comprises figures showing the antenna array pattern and the corresponding element placement pattern.

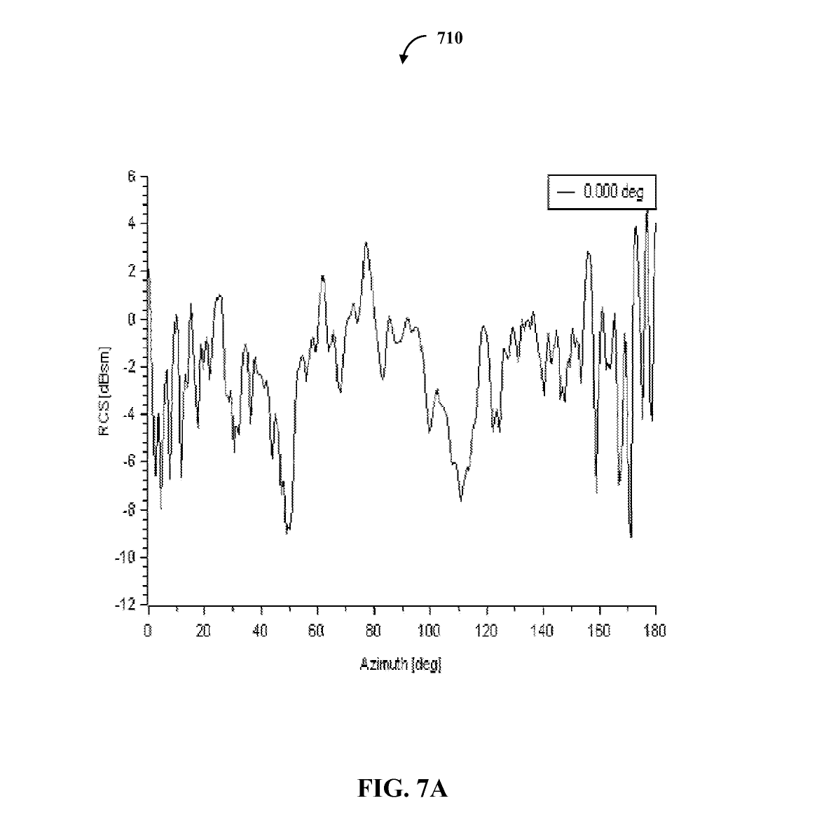

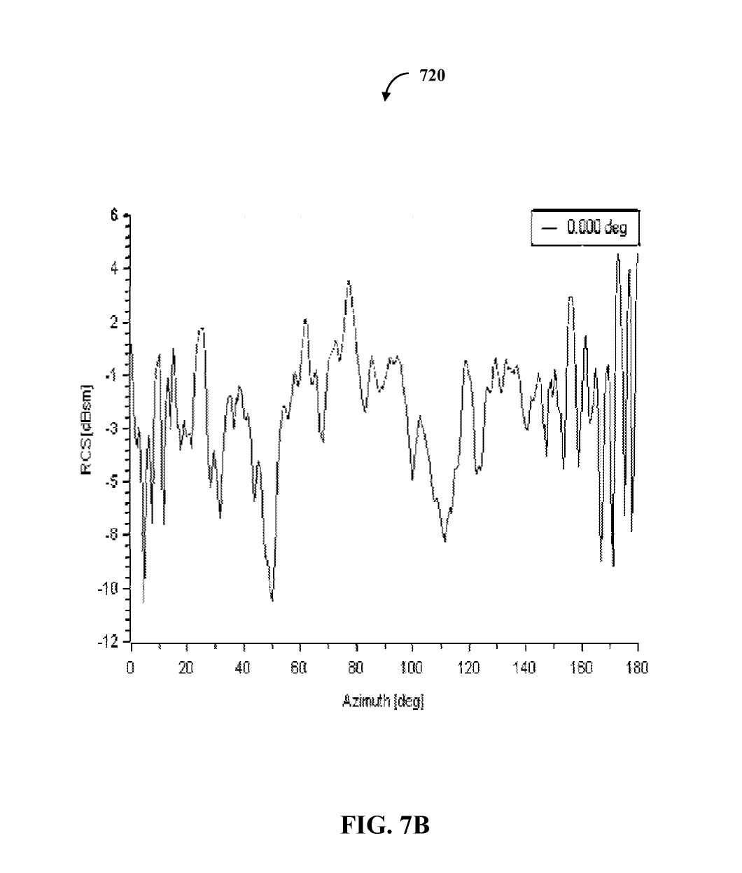

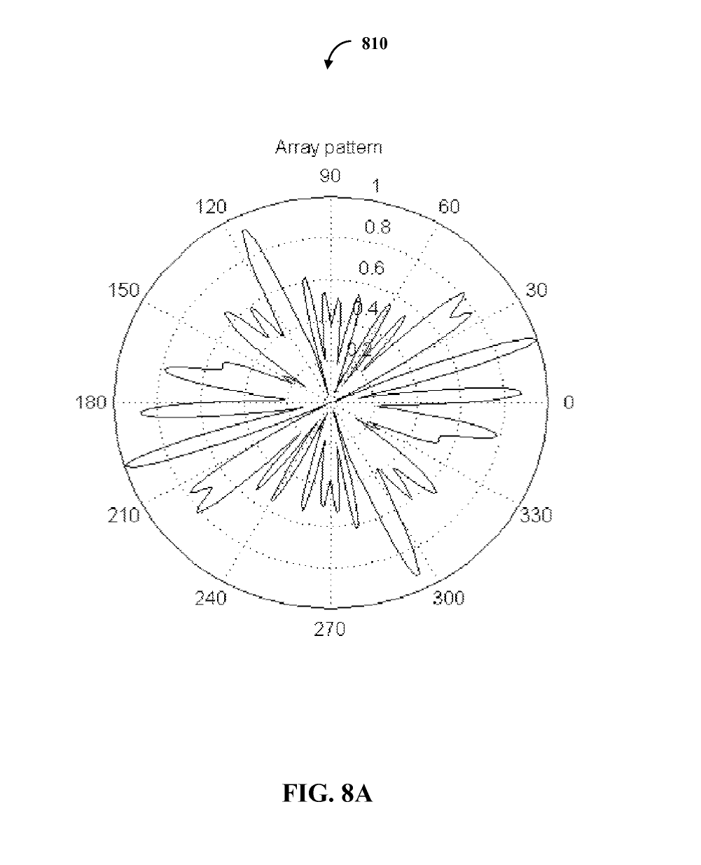

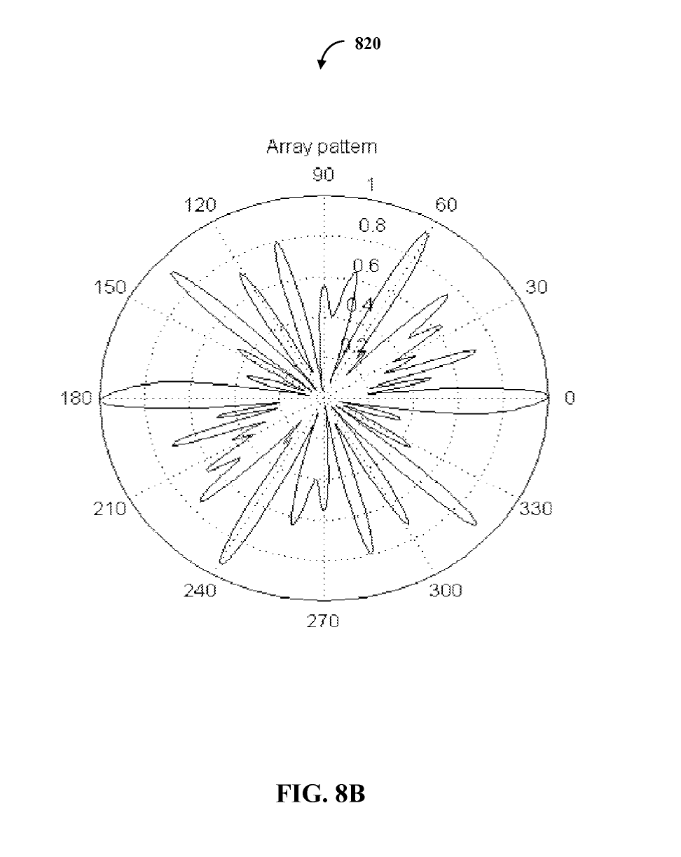

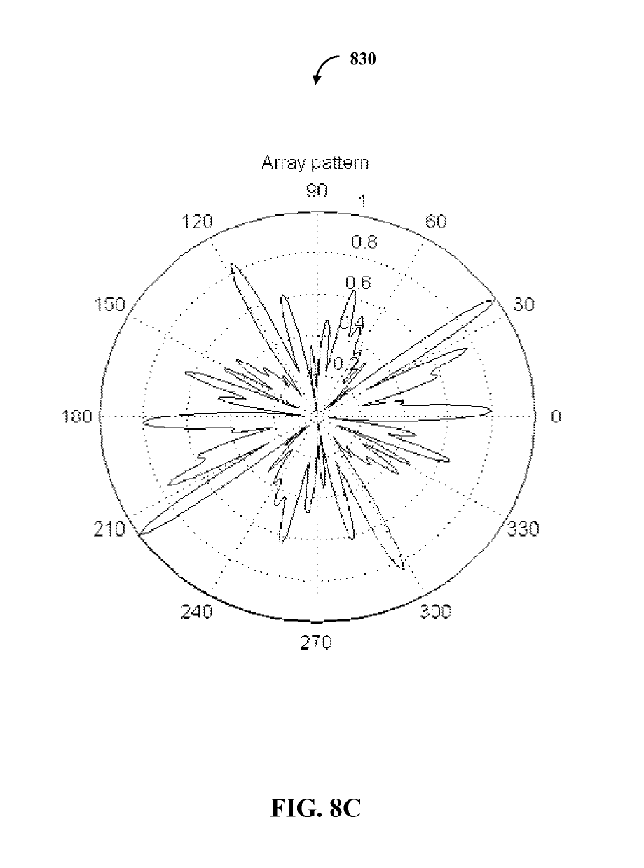

FIGS. 7A and 7B illustrate two embodiments of cross sections 710 and 720. A measured target radar cross section at 0 degrees elevation is illustrated vertically at cross section 710 and horizontally at cross section 720. These cross sections 710 and 720 show electromagnetic propagation across full spatial extent of symmetric target. It should be noted that amplitude variations exhibit a random behavior. Random element placement pattern along the perimeter of the dielectric surface can ensure a random amplitude pattern of an array factor. Together, these two items can realize a desired effect of a radar target cross section dependent on aspect angle as evidenced by the three examples shown in FIGS. 8A-8C.

FIGS. 8A, 8B, and 8C illustrate three embodiments of array patterns 810-830. These array patterns 810-830 can function as the array pattern 160. The array patterns 810-830 can be outputted by the system 100 through a parameter set 150 that comprises radius of 0.1 meters, wavelength of 18 millimeters, and 100 elements.

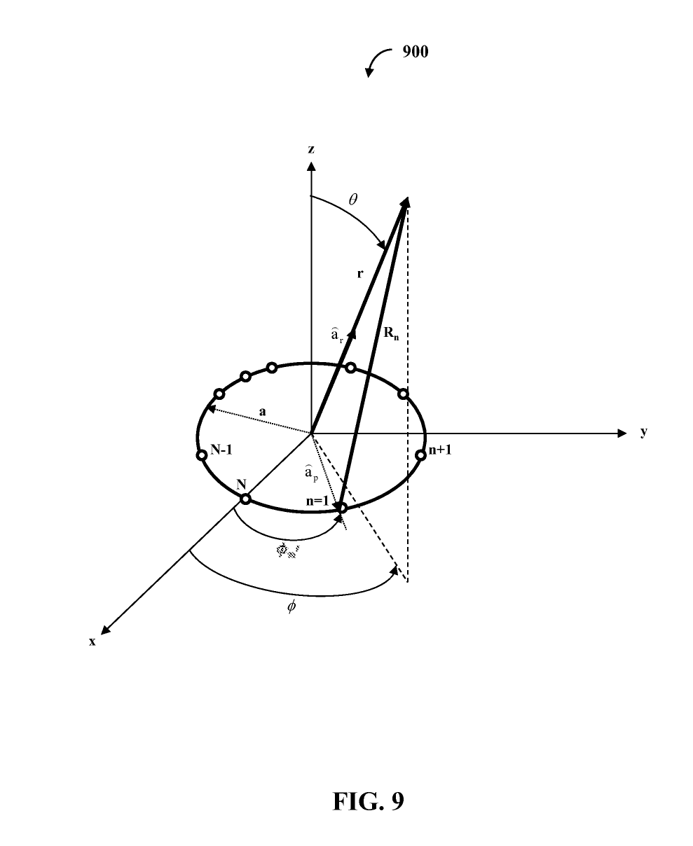

FIG. 9 illustrates one embodiment of geometry of a circular array 900. The geometry of the circular array 900 can be for a configuration having N isotropic elements randomly placed along the perimeter of a circle having radius a, azimuth support φ, and elevation support θ with an inter-element spacing d that does not equal one half of the wavelength. The normalized field of the circular array 900 can be written as

$${E}_{n} ( r , θ , φ ) = {\sum }_{n = 1}^{N} {a}_{n} \frac{{e}^{- j {kR}_{n}}}{{R}_{n}} \qquad ( 1 )$$

where Rₙ is the distance from the nth element to the object of interest. Assuming amplitude variations Rₙ≅r, Equation (1) reduces to

$${E}_{n} ( r , θ , φ ) = \frac{{e}^{- j kr}}{r} {\sum }_{n = 1}^{N} {a}_{n} {e}^{j ka si n θ co s ( φ - {φ}_{{n}^{′}} )} \qquad ( 2 )$$

where an assumption can be made that the target is in the far-field of the array (e.g., r>>a such that Rₙ=r−a sin θ cos(φ−φ_{n′}). Also shown in Equation (2) are the complex, excitation coefficients aₙ=Iₙe^{jα}^{ₙ} and the angular position φ_{n′} of the nth randomly-placed element in the x-y plane. To steer the peak of the main beam in the (θ₀, φ₀) direction, the phase excitation of the nth element is chosen as αₙ=−ka sin θ₀ cos(φ₀−φ_{n′}). Another assumption can be made that each of our N elements are uniformly excited across the circular array (although this may not be the actual case in practice), Equation (2) can be further reduced to

$${E}_{n} ( r , θ , φ ) = \frac{{e}^{- j kr}}{r} [ AF ( θ , φ ) ] \qquad ( 3 )$$

where the array factor AF(θ, φ) is defined as

$$θ , φ ) = {NI}_{0} {\sum }_{n = 1}^{N} {e}^{j ka [ s i n θ co s ( φ - {φ}_{{n}^{′}} ) - si n {θ}_{0} co s ( {φ}_{0} - {φ}_{{n}^{′}} ) ]} \qquad ( 4 )$$

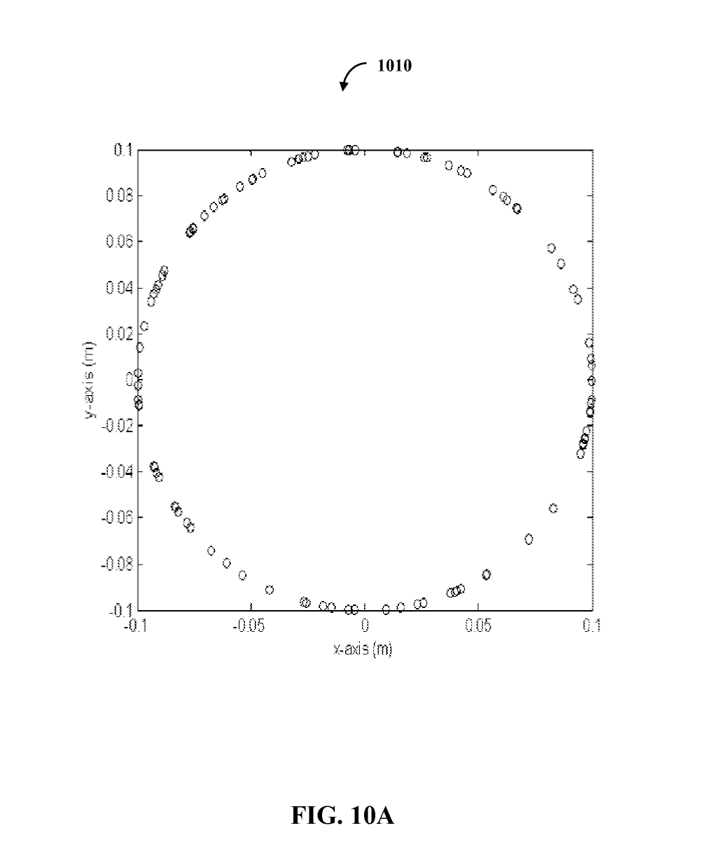

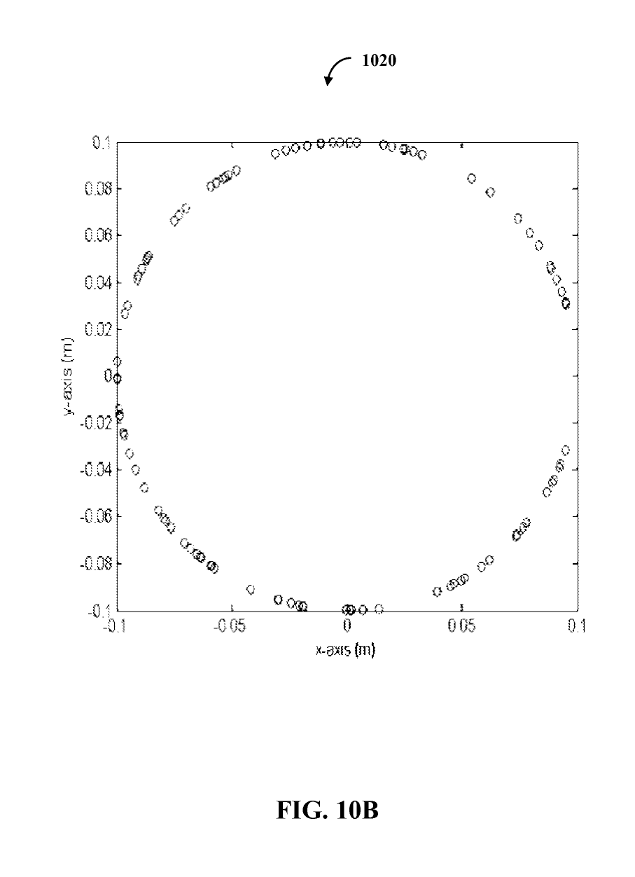

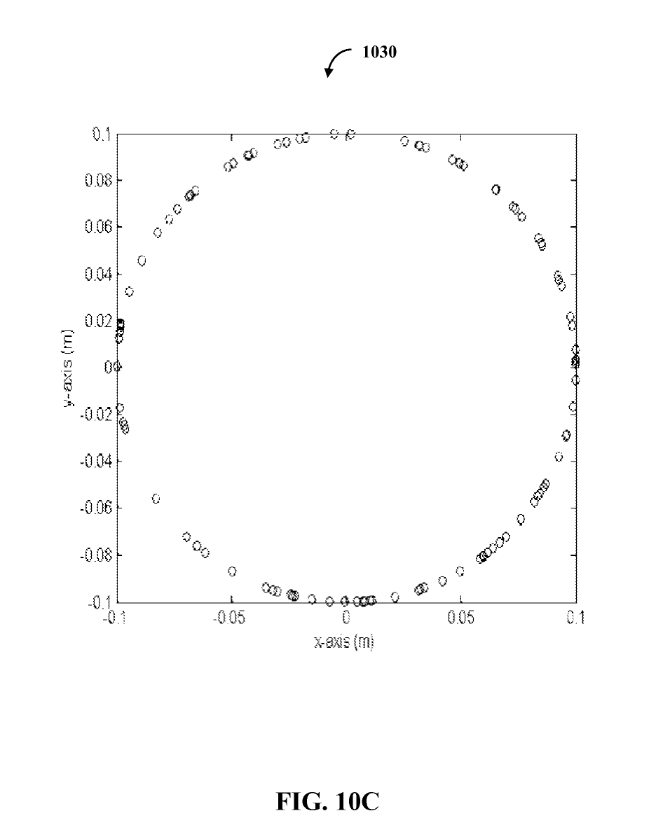

FIGS. 10A, 10B, and 10C illustrate three embodiments of element patterns 1010-1030. The element patterns 1010-1030 can be simulation outputs of three different, random element placement patterns corresponding to the three array patterns shown in FIGS. 8A-8C. The element patterns are based on circular arrays having a 0.1 m radius, 18 mm wavelength, and 100 elements. As can be seen, the elements are not evenly distributed from one another.

In one embodiment, computer code can employed to practice aspects disclosed herein. The following is sample code in MATLAB that can be employed:

%% Circular Array in the x-y plane
clear all,close all, clc
% ==== Input Parameters ====

| | |
|---|---|
| a = .1; | % radius of the circle |

| | |
|---|---|
| Z = 2*pi*a; | %perimeter of array |

| | |
|---|---|
| N = 100; | % number of Elements of the circular array |
| theta0 = 0; | % main beam Theta direction |
| phi0 = 10; | % main beam Phi direction |

% Theta or Phi variations for the calculations of the far field pattern
Variations = ‘Phi’; % Correct selections are ‘Theta’ or ‘Phi’

| | |
|---|---|
| phid = 90; | % constant phi plane for theta variations |

| | |
|---|---|
| thetad = 45; | % constant theta plane for phi variations |

% ==== End of Input parameters section ====

| | |
|---|---|
| dtr = pi/180; | % conversion factors |

rtd = 180/pi;
phi0r = phi0*dtr;
theta0r = theta0*dtr;
lambda = .018; %Ku
k = 2*pi/lambda;

| | |
|---|---|
| ka = k*a; | % Wavenumber times the radius |

jka = j*ka;

| | |
|---|---|
| I(1:N) = 1; | % Elements excitation Amplitude and Phase |

alpha(1:N) =0;
x = randn(1,N);

| for n = 1:N | % Element positions Uniformly distributed along the |
|---|---|
| | circle |

% phin(n) = 2*pi*n/N;

| | |
|---|---|
| phin(n) = k*x(n)/N; | %random EPP |

end
figure(1)
circle(0,0,a,N,phin);
switch Variations
case ‘Theta’

phir = phid*dtr; % Pattern in a constant Phi plane
i = 0;
for theta = 0.001:1:181

i = i+1;
thetar(i) = theta*dtr;
angled(i) = theta; angler(i) = thetar(i);
Array factor(i) = 0;
for n = 1:N

Arrayfactor(i) = Arrayfactor(i) + I(n)*exp(j*alpha(n)) ...

* exp(jka*(sin(thetar(i))*cos(phir −phin(n))) ...

−jka*(sin(theta0r )*cos(phi0r−phin(n))) );

end
Arrayfactor(i) = abs(Arrayfactor(i));
Element(i) = abs(sin(thetar(i)+0*dtr)); % use the abs function to
avoid

end

case ‘Phi’

thetar = thetad*dtr; % Pattern in a constant Theta plane
i = 0;
for phi = 0.001:1:361

i = i+1;
phir(i) = phi*dtr;
angled(i) = phi; angler(i) = phir(i);
Arrayfactor(i) = 0;
for n = 1:N

Arrayfactor(i) = Arrayfactor(i) + I(n)*exp(j*alpha(n)) ...

* exp(jka*(sin(thetar )*cos(phir(i)−phin(n))) ...

−jka*(sin(theta0r)*cos(phi0r −phin(n))) );

end
Arrayfactor(i) = abs(Arrayfactor(i));
Element(i) = abs(sin(thetar+0*dtr)); % use the abs function to
avoid

end

end
angler = angled*dtr;
Element = Element/max(Element);
Array = Arrayfactor/max(Arrayfactor);
ArraydB = 20*log10(Array);
EtotalR =(Element.*Arrayfactor)/max(Element.*Arrayfactor);
figure(2),plot(angled,Array)
ylabel(‘Array pattern’),grid
figure(3),polar(angler,Array)
title(‘Array pattern’)
return
switch Variations
case ‘Theta’
axis([0 180 0 1 ])
% theta = theta +pi/2;

xlabel(‘Theta [Degrees]’)
title ( ‘phi = 90\hat{ }o plane’)

case ‘Phi’
axis ([0 360 0 1 ])

xlabel(‘Phi [Degrees]’)
title ( ‘Theta = 90\hat{ }o plane’)

end
plot(angled,ArraydB)
%axis ([−1 1 −60 0])
ylabel(‘Power pattern [dB]’)
grid;
switch Variations
case ‘Theta’
axis ([0 180 −60 0 ])

xlabel(‘Theta [Degrees]’)
title ( ‘phi = 90\hat{ }o plane’)

case ‘Phi’
axis ([0 360 −60 0 ])

xlabel(‘Phi [Degrees]’)

title ( ‘Theta = 90\hat{ }o plane’)

end
polar(angler,Array)
title (‘Array pattern’)
polar(angler,ArraydB)
title (‘Power pattern [dB]’)
% the plots provided above are for the array factor based on the circular
% array plots for other patterns such as those for the antenna element
% (Element)or the total pattern (Etotal based on Element*Arrayfactor) can
% also be displayed by the user as all these patterns are already computed
% above.
figure( )
subplot(1,3,1)
polar(angler,Element, ‘b-’); % rectangular plot of element pattern
title(‘Element normalized E field [dB]’)
subplot(1,3,2)
polar(angler,ArraydB, ‘b-’)
title(‘ Array Factor normalized [dB]’)
subplot(1,3,3)
polar(angler,EtotalR, ‘b-’); % polar plot
title(‘Total normalized E field [dB]’)

What is claimed is:

1. A system, comprising:
a reception component configured to receive a parameter set;
a pattern component configured to produce an array pattern for an antenna that is based, at least in part, on the parameter set;
an element component configured to produce an element pattern for the antenna that is based, at least in part, on the parameter set; and
an output component configured to output the array pattern and the element pattern,
where:
the element pattern is such that a monitoring apparatus does not identify the antenna as an object of interest;
the array pattern is such that the monitoring apparatus does not identify the antenna as the object of interest, and
the reception component, the pattern component, the element component, the output component, or a combination thereof are implemented, at least in part, as non-software.

2. The system of claim 1, where the array pattern is randomized, where the element pattern is randomized, and where the element pattern is a circular pattern.

3. The system of claim 1, where the parameter set comprises an antenna parameter set.

4. The system of claim 3, where the antenna parameter set comprises an array radius and an element number.

5. The system of claim 1, where the parameter set comprises an equation variable set.

6. The system of claim 5, where the equation variable set comprises a carrier frequency and a beam steering angle set.

7. The system of claim 1, where the element pattern is a distribution of a plurality of elements along a circular pattern with a specific angle for individual elements of the plurality of elements.

8. A non-transitory computer-readable medium that stores processor-executable instructions that when executed by a processor cause the processor to perform a method, the method comprising:
collecting a parameter set;
generating a pattern set; and
causing the pattern set to be outputted,
where:
the pattern set comprises a randomized array pattern for an antenna that is based, at least in part, on the parameter set that is such that a monitoring apparatus does not identify the antenna as an object of interest and
the pattern set comprises a randomized element pattern for the antenna that is based, at least in part, on the parameter set and that is such that the monitoring apparatus does not identify the antenna as the object of interest.

9. The non-transitory computer-readable medium of claim 8, where the pattern set is generated through use of a normalized electric field formula.

10. The non-transitory computer-readable medium of claim 8, where the pattern set is generated through use of an array factor formula.

11. The non-transitory computer-readable medium of claim 8, where the parameter set comprises an antenna parameter set.

12. The non-transitory computer-readable medium of claim 11, where the antenna parameter set comprises an array radius and an element number.

13. The non-transitory computer-readable medium of claim 8, where the parameter set comprises an equation variable set.

14. The non-transitory computer-readable medium of claim 13, where the equation variable set comprises a carrier frequency and a beam steering angle set.

15. The non-transitory computer-readable medium of claim 8, where the randomized element pattern is distribution of a plurality of elements along a circular pattern with a specific angle for individual elements of the plurality of elements.

16. A system, comprising:
a processor;
a non-transitory computer-readable storage medium communicatively coupled to the processor and storing processor executable components to facilitate operation of components comprising:
a reception component that receives a parameter set, the parameter set comprising an antenna parameter set and an equation variable set;
a production component that produces a pattern set that is based, at least in part, on the parameter set; and
an output component that causes output of the pattern set,
where:
the pattern set comprises a randomized array pattern for an antenna and a randomized element pattern for the antenna,
the randomized element pattern is such that a monitoring apparatus does not identify the antenna as an object of interest, and
the randomized array pattern is such that the monitoring apparatus does not identify the antenna as the object of interest.

17. The system of claim 16, where:
the antenna parameter set comprises an array radius and an element number and
the equation variable set comprises a carrier frequency and a beam steering angle set.

18. The system of claim 17, where the pattern set is produced through use of an array factor formula and through use of a normalized electric field formula.

19. The system of claim 18, where:
the antenna is a first antenna,
the pattern set is a first pattern set,
the randomized array pattern is a first randomized array pattern,
the randomized element pattern is a first randomized element pattern,
the production component produces a second pattern set that is based, at least in part on the parameter set,
the second pattern set comprises a second randomized array pattern that is for a second antenna that is different from the first randomized array pattern for the first antenna,
the second pattern set comprises a second randomized element pattern for the second antenna that is different from the first randomized array pattern for the first antenna,
the second randomized element pattern is such that the monitoring apparatus does not identify the second antenna as the object of interest;
the second randomized element pattern is a distribution of a plurality of elements along a circular pattern with a specific angle for individual elements of the plurality of elements;
the second randomized array pattern is such that the monitoring apparatus does not identify the second antenna as the object of interest, and
the second pattern set is produced through use of the array factor formula and through use of the normalized electric field formula.

20. The system of claim 19, where the first randomized element pattern and the second randomized element pattern are a distribution of a plurality of elements along a circular pattern with a specific angle for individual elements of the plurality of elements.
